(19) United States
(12) Patent Application Publication
(10) Pub. No.: US 2026/0206078 A1
(43) Pub. Date: Jul. 16, 2026

(54) POLLING SEQUENCE

(71) Applicant: STMICROELECTRONICS INTERNATIONAL N.V., Geneva (CH)

(72) Inventors: Jean-Marc GRIMAUD, Biot (FR); Arach MOHAMMED BRAHIM, Antibes (FR)

(21) Appl. No.: 19/446,009

(22) Filed: Jan. 12, 2026

(30) Foreign Application Priority Data
Jan. 13, 2025 (EP) 25315013.0
Jun. 30, 2025 (FR) 2507342

(51) Int. Cl. H04W 76/14; H04W 4/80

(52) U.S. Cl. CPC H04W 76/14; H04W 4/80

(57) ABSTRACT

The present disclosure relates to a method and a device for near-field communication using a polling frame comprising at least one parameterizable datum.

### CROSS REFERENCE TO RELATED APPLICATION(S

This application claims priority to French Patent Application number 2507342, filed on June 30, 2025, entitled “trame d’interrogation”, and to European Patent Application Number 25315013.0, filed on January 13, 2025, entitled “POLLING SEQUENCE”, the contents of each of which are incorporated by reference to the maximum extend authorized by law.

### Technical Field

The present disclosure generally relates to electronic systems and devices, and to means of communication between such electronic systems and devices. The present disclosure relates more particularly to communications using NFC (Near Field Communication) technology, and to polling frames used during the implementation of such communications.

### Background

Most wireless communications, such as NFC (Near Field Communication) communications, are initiated by polling frames. A polling frame is a data frame sent by a device suitable for implementing wireless communication to "call" another device and initiate wireless communication.

It would be desirable to be able to improve, at least in part, some aspects of wireless communications and wireless communication devices.

### Brief Summary

There is a need for more efficient wireless communication methods between two electronic devices.

There is a need for more efficient NFC communication methods between two electronic devices.

There is a need for NFC communication methods and NFC communication devices using parameterizable polling frames.

One embodiment overcomes all or some of the drawbacks of known NFC communication methods.

One embodiment overcomes all or some of the disadvantages of known NFC communication devices.

One embodiment provides an NFC communication method and an NFC communication device, using parameterizable polling frames.

One embodiment provides an NFC communications method and an NFC communications device, using polling frames that do not conform to the rules for establishing a standard polling frame.

One embodiment provides a near-field communication method using a polling frame comprising at least one parameterizable datum.

One embodiment provides a near-field communication device suitable for using a polling frame comprising at least one parameterizable datum.

According to one embodiment, the at least one first parameterizable data comprises a request.

According to one embodiment, the request comprises a maximum response time.

According to one embodiment, the at least one parameterizable datum has a minimum size of 8 bits.

According to one embodiment, the at least one parameterizable datum has a maximum size of 128 bits.

According to one embodiment, the at least one parameterizable datum is arranged at the beginning of the polling frame.

According to one embodiment, the at least one parameterizable datum is arranged between second standardized data different from the parameterizable datum.

According to one embodiment, the second standardized data comprises a succession of one or more of the following data, in the stated order: - a A-type request datum; - a B-type request datum; - a F-type request datum; and - a V-type request datum.

According to one embodiment, the use of the request frame is launched by a software intervention associated with or related to a software operation or associated with related to a mechanical operation.

One embodiment provides a device suitable for generating the polling frame.

One embodiment provides a device suitable for receiving the polling frame.

One embodiment provides a system comprising a device as described.

One embodiment provides a computer program comprising program code instructions for performing the steps of the described method when the program is run on a computer being one of the described devices.

### Brief Description of the Drawings

The foregoing features and advantages, as well as others, will be described in detail in the following description of specific embodiments given by way of illustration and not limitation with reference to the accompanying drawings, in which:

FIG. 1 illustrates, very schematically and in block form, an example electronic device;

FIG. 2 illustrates, very schematically and in block form, an example implementation of a NFC communication;

FIG. 3 illustrates an example NFC communication polling frame;

FIG. 4 illustrates an embodiment of an NFC communication polling frame; and

FIG. 5 illustrates an NFC communication embodiment mode using the embodiment shown in FIG. 4.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms "front", "back", "top", "bottom", "left", "right", etc., or to relative positional qualifiers, such as the terms "above", "below", "higher", "lower", etc., or to qualifiers of orientation, such as "horizontal", "vertical", etc., reference is made to the orientation shown in the figures.

Unless specified otherwise, the expressions "around", "approximately", “substantially” and "in the order of" signify within 10% or 10°, and preferably within 5% or 5°.

The embodiments described hereinafter relate to the implementation of near field communication, or NFC (Near Field Communication) communication, and the polling frames used to initiate such a near field communication. Polling frames are data frames defined by a standard. The embodiments described hereinafter relate to the use of parameterizable polling frames that include data not provided for by the standard.

The use of such parameterizable polling frames enables the use of NFC communication devices which are not capable of responding to polling frames defined by a standard. This can, for example, allow the types of NFC communication devices that can communicate with each other to be diversified without taking the place of NFC communication devices using standard polling frames.

In addition, the embodiments described above are particularly suitable for use in any type of industrial market where NFC communication is required. In particular, such NFC communication can be intended to: - the automotive industry, for example in the field of automotive electrification or in the field of Advanced Driver Assistance Systems (ADAS); - the industrial sector, for example in the field of green energy, in the field of electrifying infrastructure, Internet of Things (IoT) and SmartHomes, where electricity and energy consumption and data exchange are key elements; - the personal electronics industry, for example in mobile telephony and the Internet of Things (IoT), as well as in high speed interfaces; and - the communications equipment, computer and peripherals industry, for example in the field of infrastructure and data centers, and in the field of Low Earth Orbit (LEO) satellites.

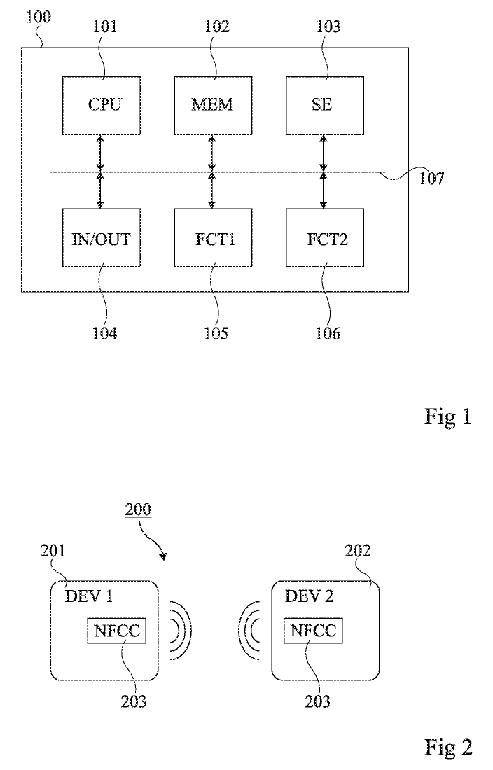

FIG. 1 is a block diagram very schematically illustrating an architecture of an example electronic device 100 suitable for implementing NFC communication.

According to one example, the electronic device 100 comprises a processor 101 (CPU) suitable for implementing different processing on data stored in memories and/or provided by other circuits of the device 100. According to one embodiment, the processor 101 may be suitable for implementing an NFC communication method.

According to one example, the electronic device 100 further comprises different types of memory 102 (MEM), including, for example, a non-volatile memory, a volatile memory, and/or a read-only memory. Each memory 102 can be suitable for storing different types of data.

According to one example, the electronic device 100 further comprises, for example, a secure element 103 (SE) suitable for handling sensitive and/or secret data. The secure element 103 may comprise its own processor(s), memory(s), etc. According to one embodiment, the secure element 101 may be suitable for implementing an NFC communication method.

According to one example, the electronic device 100 may further comprise interface circuits 104 (IN/OUT) suitable for sending and/or receiving data from outside the device 100. The interface circuits 104 can be further suitable for implementing a data display, for example, a display screen. According to one embodiment, one of the interface circuits 104 may be suitable for implementing an NFC communication method.

According to one example, the electronic device 100 further comprises different circuits 105 (FCT1) and 106 (FCT2) suitable for performing various functions. By way of example, circuits 105 and 106 can comprise measurement circuits, data conversion circuits, etc. According to one embodiment, circuits 105 and 106 may comprise a particular circuit suitable for implementing an NFC communication method.

According to one example, the electronic device 100 further comprises one or more data buses 107 suitable for transferring data between its various components.

According to one particular example, the electronic device 100 is suitable for implementing computer programs, and, especially, a computer program enabling to implement a wireless communication, such as NFC communication, method for example a computer program enabling to implement a terminal-side and/or card-side NFC communication method.

More precisely, the electronic device 100 is suitable for implementing at least one computer program product comprising program code instructions recorded on a medium usable in a computer, comprising computer-readable programming means for implementing the NFC communication method as a terminal device and/or as a card device when the program runs on a computer.

FIG. 2 illustrates, very schematically and in block form, a wireless 200 and contactless communication between an electronic device 201 (DEV1) serving as a terminal which may be mobile, or mobile terminal 201, and an electronic device 202 (DEV2) serving as a remote module, or remote module 202, also referred to as card module 202.

According to one embodiment, the wireless and contactless communication 200 under consideration uses, for its implementation, a near-field communication technology, hereinafter referred to as NFC communication. Near Field Communication (NFC) technologies enable high-frequency, short-range communications. Such systems exploit a radio-frequency electromagnetic field transmitted from one device (terminal or reader) to communicate with another device (remote module, transponder, or card). According to one example, such wireless communication can enable to implement a wireless transaction, or NFC transaction. A transaction is defined here as a particular communication the purpose of which is a commercial, monetary, loyalty and/or authorization operation in which one device, the terminal 201, is the "payment" or "control" terminal implementing the transaction, and the other device, the remote module 202, is the one accepting the transaction or not.

We are assuming here the case of two electronic devices, for example the terminal 201 and the remote module 202, but everything that will be described applies more generally to any system in which a transponder captures an electromagnetic field radiated by a reader, station or terminal. Terminal 201 and remote module 202 are, for example, electronic devices of the type of device 100 described in connection with FIG. 1. In this type of communication, electronic devices 201 and 202 are positioned within range of each other, i.e. at a distance generally less than 10 cm. According to another example, devices 201 and 202 are in mechanical contact with each other.

Depending on the application, for an NFC communication, one of the devices, the terminal 201, operates in so-called reader mode, while the other, the remote module 202, operates in so-called card mode, or the two devices communicate in peer-to-peer (P2P) mode. Each device includes various electronic circuits 203 (NFCC) suitable for transmitting, receiving, and/or modulating a radio-frequency (RF) signal transmitted using an oscillating/resonant circuit antenna. The RF field generated by one of the devices, e.g. terminal 201, is picked up by the other device, e.g. remote module 202, which is within range and also features an antenna. When the terminal 201 transmits an electromagnetic field to initiate communication with the remote module 202, this field is picked up by the remote module 202 as soon as it is within range. This field is detected by the circuits 203 of the remote module 202 which, if they are in standby mode, are reactivated. In some cases, depending on the type of device, the remote device captures the field energy (along with the communication data) and uses it to power itself. In this case, a start-up of the remote device (202) is required. This results in a variation of the load formed by the circuits 203 of the remote module 202 on the field-generating resonant circuit of the terminal 201. In practice, the corresponding variation in phase or amplitude of the transmitted field is detected by the terminal 201, which then initiates an NFC communication protocol with the remote module 202. On the terminal 201 side, in practice, it is detected whether the amplitude of the voltage across the resonant circuit drops below a threshold, or whether the voltage across the resonant circuit has a phase shift greater than a threshold. Once the terminal 201 has detected the presence of the remote module 202 in its field, it initiates a communication set-up procedure, implementing the transmission of requests by the terminal 201 and responses by the remote module 202. Request and response transmissions are described in greater detail with reference to FIG. 4.

According to one example, the terminal 201 is an electronic device which can be, for example, fixed or mobile. The terminal 201 is responsible for initiating communication.

The remote module 202 is a generally mobile device. According to one example, the remote module 202 is a microcircuit card (or smart card), for example a bank card or a transport card. According to another example, the remote module 202 could be a cell phone suitable for implementing an application enabling it to reproduce, simulate, or emulate, the behavior of one or more microchip cards. The remote module 202 comprises various electronic circuits suitable for implementing various requests sent by the terminal 201, such as authentication circuits, cryptography circuits, etc.

In recent systems, the same NFC device can operate in card mode or reader mode (for example, in the case of near-field communication between two cell phones), and can choose, depending on the case, whether it operates in card mode or reader mode. According to one example, the module 201 could be used as a reader or terminal to implement a payment transaction, and, in another case, be used as a card, for example, to validate a transport ticket.

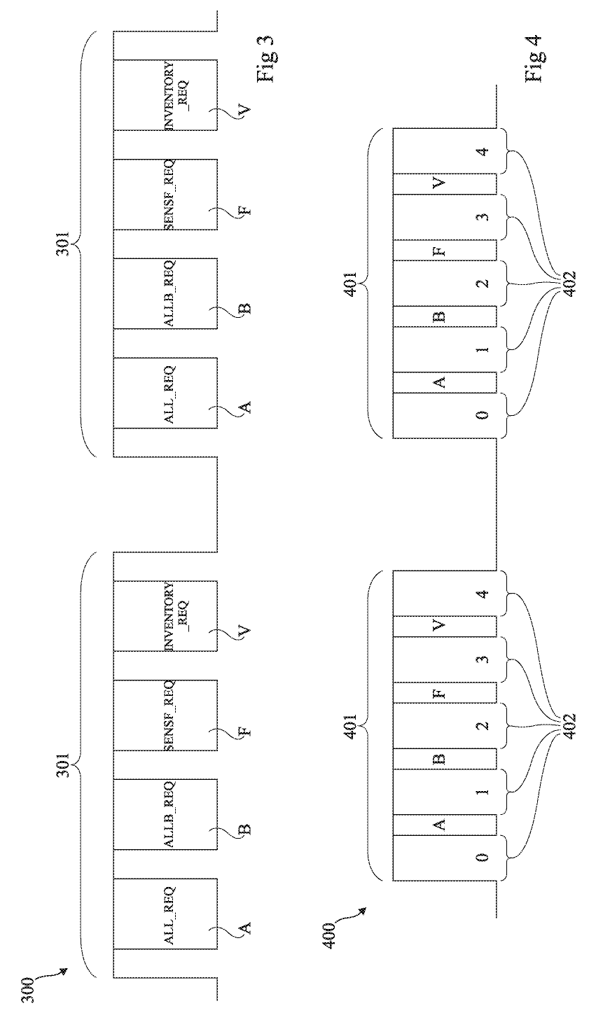

According to a particular embodiment, the wireless communication 200 is an NFC communication following the communication protocol set by the ISO 14443 standard. The key elements of this communication protocol in relation to the embodiments described here are described with reference to FIG. 3.

FIG. 3 schematically illustrates initialization data 300 for an NFC communication.

The initialization data 300 is suitable for use in starting an NFC communication of the type of communication 200 described with reference to FIG. 2. More particularly, the initialization data 300 is generated by an electronic device of the type of device 100 described with reference to FIG. 1, and is used by this device to "call" another electronic device and start an NFC communication with this other device.

According to one example, initialization data 300 comprises one or more, usually several, polling frames 301. A polling frame is a set of data comprising information about the type of NFC device and/or communication that the device generating it wishes to implement. Sending a polling frame 301 means switching on the circuits implementing NFC communication, and in particular generating an electromagnetic field, and sending a request to an electronic device to implement an NFC communication.

More precisely, a standard polling frame is a data frame that can comprise a succession of four standardized data commonly referred to as "A", "B", "F" and "V", separated from one another by silent durations, i.e. durations during which no data is transmitted. These four data "A", "B", "F", and "V" are always quoted in this order, but these four data are not necessarily all always present. According to one example, data "A" is a request data of type "A". According to one example, data "B" is a request data of type "B". According to one example, data "F" is a request data of type "F". According to one example, data "V" is a request data of type "V". These four data are all precisely defined by NFC communication standards, such as ISO 14443.

In FIG. 3, each polling frame 301 comprises: - standardized data A (ALL_REQ); - standardized data B (ALLB_REQ) directly following a silent duration and standardized data A; - standardized data F (SENSF_REQ) directly following a silent duration and standardized data B; and - standardized data V (INVENTORY_REQ) directly following a silent duration and standardized data F.

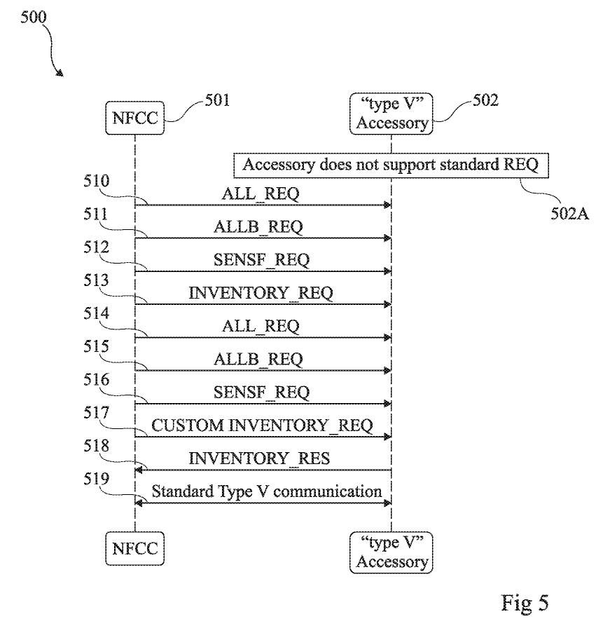

As previously stated, data A, B, F, and V are defined by a standard, and any electronic device not following this standard cannot enter into communication with an electronic device using polling frames of the type of frames 301. To solve this problem, the embodiments described with reference to FIGS. 4 and 5 provide the use of parameterizable polling frames.

FIG. 4 schematically illustrates an embodiment of an NFC communication initialization data 400.

According to one embodiment, initialization data 400 comprises one or more, generally several, polling frames 401. Unlike the polling frames 301 described with reference to FIG. 1, the polling frames 401 are parameterizable polling frames. According to one embodiment, parameterizable polling frames are polling frames comprising, in addition to one or more standardized data, parameterizable data which is transmitted at the time of silent durations. These parameterizable data are, for example, defined by the manufacturer and do not comply with the NFC communications standard, i.e. ISO 14443. These parameterizable data are, for example, data identical to the standardized request data, or request data different from the standardized request data. According to one embodiment, these parameterized data are data adapted to make particular NFC communication devices react.

Thus, in FIG. 4, each request frame 401 may comprise: - standardized data A; - standardized data B; - standardized data F; - standardized data V; and - one or more parameterizable data 402 transmitted during silent durations present between the standardized data A, B, F and V, each silent duration corresponding to a parameterizable location.

According to one embodiment, five silent durations 0 to 4 that can accommodate parameterizable data can be defined within a polling frame 401. In particular: - a first silent duration 0 is present before the standardized data A is sent; - a second silent duration 1 is present after standardized data A has been sent and before standardized data B has been sent; - a second silent duration 2 is present after standardized data B has been sent and before standardized data F is sent; - a second silent duration 3 is present after standardized data F has been sent and before standardized data V is sent; and - a second silent duration 4 is present after standardized data V has been sent.

As mentioned previously, the four data A, B, F and V are always quoted in the same order, but these four data are not necessarily always all present. Thus, a polling frame 401 may contain several contiguous parameterizable locations. In addition, a polling frame 401 may not contain all the silent durations 0 to 4 illustrated here.

According to one embodiment, each silent duration may comprise one or more parameterizable data 402. These parameterizable data 402 enable to send a request to a particular electronic device that does not respond to the standardized A, B, F and V data requests for implementing NFC communication. According to a preferred embodiment, the one or more parameterizable data 402 comprises a request calling for a response from an external device. In addition, the one or more parameterizable data 402 may further include data indicating a maximum response time, i.e. information indicating a maximum duration that must not be exceeded for a response from an external electronic device to enable an NFC communication to be initiated.

According to one example, each parameterizable data 402 may have a minimum size of 8 bits, or one byte, and a maximum size of 128 bits, i.e. 16 bytes.

According to one embodiment, an NFC communication device is, for example, suitable for using such a parameterizable polling frame 401 following the reception of an intervention, such as a software intervention, which may itself be initiated by a software manipulation or a mechanical manipulation of the NFC communication device, for example by a user.

The present description therefore relates to the implementation of an embodiment of an NFC communication using a polling frame of the frame 401 type, but also a mode of implementation of an electronic device suitable for using such a polling frame. More specifically, the present description relates to: - an NFC communication method of the type of NFC communication 200 described with reference to FIG. 2 using a polling frame of the type of polling frame 401; - an electronic device of the type of the electronic device 100 described with reference to FIG. 1 suitable for generating a polling frame of the type of polling frame 401; - an electronic device of the type of the electronic device 100 described with reference to FIG. 1 suitable for receiving and interpreting a polling frame of the type of polling frame 401; - a system comprising electronic devices suitable for using a polling frame of the type of polling frame 401 for implementing an NFC communication; - a computer program comprising program code instructions for performing the steps of an NFC communication method when the program runs on a computer as the device suitable for generating a polling frame of the type of polling frame 401; and - a computer program comprising program code instructions for performing the steps of an NFC communication method when the program runs on a computer as the device suitable for receiving and interpreting a polling frame of the type of polling frame 401.

FIG. 5 illustrates an example implementation of an NFC communication 500 using a polling frame of the type of the polling frame 401 embodiment described with reference to FIG. 4.

The NFC communication 500 is a communication between a first electronic device comprising an NFC module 501 (NFCC) suitable for implementing the communication 500, and a second electronic device 502 ("Type V" Accessory) suitable for implementing the NFC communication 500.

According to one embodiment, the device 502 is in a state 502A (Accessory does not support standard REQ) indicating that it is not suitable for interpreting the standardized A, B, F, and V data described above. It is therefore necessary to use a parameterizable polling frame to implement communication 500. More particularly, in the example shown in FIG. 5, the device 502 is suitable for responding to a parameterizable data similar to a standardized data V described previously, but not conforming to the standard.

In an initial step 510 (ALL_REQ), the NFC module 501 starts sending a polling frame by sending a standardized data A described above.

In a step 511 (ALLB_REQ), following, for example, directly, step 510, NFC module 501 proceeds with sending the polling frame by sending a standardized data B described above.

In a step 512 (SENSF_REQ), following, for example directly, step 511, NFC module 501 proceeds with sending the polling frame by sending a standardized data F described above.

In a step 513 (SENSF_REQ), following, for example directly, step 512, NFC module 501 proceeds with sending the polling frame by sending a standardized data V described above.

In a step 514 (SENSF_REQ), following, for example directly, step 513, NFC module 501 has received no response from any electronic device, and in particular none from device 502. The NFC module therefore starts sending a second polling frame again by sending a standardized data A.

In a step 515 (ALLB_REQ), following, for example directly, step 514, NFC module 501 proceeds with sending the second polling frame by sending a standardized data B described above.

In a step 516 (SENSF_REQ), following, for example directly, step 515, NFC module 501 proceeds with sending the second polling frame by sending a standardized data item F described above.

In a step 517 (CUSTOM_INVENTORY_REQ), following, for example directly, step 516, NFC module 501 proceeds with sending the second polling frame by sending, not a standardized data item V, but a parameterizable data. According to an example not illustrated in FIG. 5, step 517 could be followed by a step for sending standardized data V.

In a step 518 (INVENTORY_RES), following, for example directly, step 517, the device 502 has received the parameterizable data which it is able to interpret, and responds to the NFC module with a answer suitable for initiating the implementation of an NFC communication.

In a step 519 (Standard Type V communication), following, for example directly, step 518, an NFC communication is established between the NFC module 501 and the electronic device 502.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

1. A near-field communication method using a polling frame comprising at least one parameterizable datum.

2. The near-field communication method of claim 1, wherein the at least one parameterizable datum includes a first parameterizable datum that comprises a request.

3. The near-field communication method of claim 2, wherein the request comprises a maximum response time.

4. The near-field communication method of claim 1, wherein the at least one parameterizable datum has a minimum size of 8 bits.

5. The near-field communication method of claim 1, wherein the at least one parameterizable datum has a maximum size of 128 bits.

6. The near-field communication method of claim 1, wherein the at least one parameterizable datum is arranged at a beginning of the polling frame.

7. The near-field communication method of claim 1, wherein the at least one parameterizable datum is arranged between a second standardized data different from the at least one parameterizable datum.

8. The near-field communication method of claim 7, wherein the second standardized data comprise a succession of one or more of a following data, in a stated order of:
a A-type request datum; a B-type request datum; a F-type request datum; and a V-type request datum.

9. The near-field communication method of claim 1, wherein a use of a request frame is triggered by a software intervention associated with a software operation or associated with a mechanical operation.

10. A near-field communication device configured for using a polling frame comprising at least one parameterizable datum.

11. The near-field communication device of claim 10 further configured for generating the polling frame.

12. The near-field communication device of claim 10 further configured for receiving the polling frame.

13. The near-field communication device of claim 10, wherein the at least one parameterizable datum includes a first parameterizable datum that comprises a request, and wherein the request comprises a maximum response time.

14. The near-field communication device of claim 10, wherein the at least one parameterizable datum has a minimum size of 8 bits.

15. The near-field communication device of claim 10, wherein the at least one parameterizable datum is arranged at a beginning of the polling frame.

16. The near-field communication device of claim 10, wherein the at least one parameterizable datum is arranged between a second standardized data different from the at least one parameterizable datum.

17. The near-field communication device of claim 16, wherein the second standardized data comprise a succession of one or more of a following data, in a stated order of:
a A-type request datum; a B-type request datum; a F-type request datum; and a V-type request datum.

18. The near-field communication device of claim 10, wherein a use of a request frame is triggered by a software intervention associated with a software operation or associated with a mechanical operation.

19. A computer program comprising program code instructions for performing the near-field communication method of claim 1, wherein the computer program is run on a computer being a near-field communication device configured for using a polling frame comprising at least one parameterizable datum and for generating the polling frame.

20. A computer program comprising program code instructions for performing the near-field communication method of claim 1, wherein the computer program is run on a computer being a near-field communication device configured for using a polling frame comprising at least one parameterizable datum and for receiving the polling frame.
